(19) United States
(12) Patent Application Publication
(10) Pub. No.: US 2017/0171117 A1
(43) Pub. Date: Jun. 15, 2017

(54) Message Suggestion Using Dynamic Information

(71) Applicant: International Business Machines Corporation, Armonk, NY (US)

(72) Inventors: KEVIN C. CARR, RALEIGH, NC (US); AL CHAKRA, APEX, NC (US); JEREMY CRAFTS, Raleigh, NC (US); BRYAN M. DEMPSEY, Clinton Corners, NY (US); MARIT L. IMSDAHL, Morrisville, NC (US)

(21) Appl. No.: 14/965,835

(22) Filed: Dec. 10, 2015

(51) Int. Cl. H04L 12/58

(52) U.S. Cl. CPC H04L 51/02; H04L 51/04; H04L 51/26

(57) ABSTRACT

An automatic message suggestion generation computer system, computer-implemented method and computer program product. In a system implementing a messaging service, messages received by a mobile device under an active message session are dynamically forwarded to a messaging engine for processing and storage in computer memory of information associated with the active message sessions. Upon the receipt of information associated with a message, a determination is made as to a correlation between the currently received information and stored information associated with a prior message. If a correlation is determined, at least one suggested message is generated based on correlated information. Example message services include SMS, MMS, IMS and EIM. Suggested messages can be supplemented by available historical information such as might be contained in social networking services, calendaring and e-mail services and contextual information such as location, time of day, motion, and direction of travel.

### BACKGROUND

The present invention relates to electronic communication. In particular, the present invention relates to systems, methods and computer program products for the automatic generation of a suggested message. Today, many text completion and auto-correct tools are available for use with text messages. Although such tools make our lives easier, a need for improvement remains.

### SUMMARY

A computer-implemented message processing and suggestion generation process in accordance with the present invention includes the receipt by a device of information associated with a first message under a first active message session and the processing and storing of one or more portions of the information. Upon the subsequent receipt by the device of information associated with another message under another active message session, at least portions of the information associated with a first message are retrieved and a determination made as to a correlation between the information associated with the messages. If a correlation is determined, at least one suggested message is generated and provided to the device based on the correlated information.

In some embodiments, the device is a mobile device and the processing, retrieval and message suggestion generating are performed by the mobile device. In some embodiments, the messaging services include one or more of a short messaging service (SMS), a multimedia messaging service (MMS), an instant messaging service (IMS) and an enterprise instant messaging service (EIM).

In some embodiments, the message processing and suggestion generation process incorporates one or more of priority information and access information stored in the device and retrieved in response to the receipt of the subsequent message. In some embodiments, the message processing and suggestion generation process incorporates available contextual information such as location, time of day, motion, and direction of travel. In some embodiments, the message processing and suggestion generation process incorporates accessible social networking service information associated with the message receiver.

Other embodiments of the present invention, including system and computer program product are described herein.

### BRIEF DESCRIPTION OF THE SEVERAL VIEWS OF THE DRAWINGS

FIG. 1A illustrates an example of a system in accordance with the present invention.

FIG. 1B illustrates an example of user interfaces of devices depicted in FIG. 1A.

FIG. 2 illustrates a more detailed example of the messaging engine depicted in FIG. 1.

FIGS. 3A and 3B illustrate an example of a computer-implemented method in accordance with the present invention.

### DETAILED DESCRIPTION

By way of introduction, the following description shows various embodiments of the present invention. Conventional devices, components, techniques and other functional and individual components thereof understood by one of ordinary skill in the art may not be described in detail. By way of example only, the devices/servers/data sources referenced in the various embodiments herein are understood to include conventional hardware (such as processor(s), computer memory) software, and firmware components collectively configured to perform the functions described. On the other hand, specifics are in many cases provided merely for ease of explanation or understanding the various embodiments and possible variations thereof. The various embodiments of the present invention described herein should not be construed as limiting the numbers, types or combinations of networks, devices, servers, services or components within the scope of the present invention. Other networks, devices, servers, services, systems, applications, or components (not shown) may also be present.

One conventional form of messaging service is commonly referred to as instant messaging (IM) services (IMS). Basic IMS (aka online chat services) offer on-demand/real-time transmission of text messages over a network. Also, as is known, some IMS' offer enhanced features, such as video calling and web conferencing services that integrate video with voice over IP (VOIP), and desktop sharing. As is known, social network services sometimes offer IMS functionality. For example, Facebook® offers a form of IM as part of its social network services, and Twitter® services can be thought of as a form of instant messaging service. Other social network services, such as more dating-focused services, offer online chat features. Enterprise instant messaging (EIM) services were developed in response to business demand for improved security and legal compliance for IM services. Some EIM offerings offer interoperability with other EIM networks and some public IM networks (such as IM services available from Yahoo! Inc.) so that enterprise employees may use one interface for both their internal EIM system and their contacts on public IM networks. EIM features are more frequently integrated with enterprise e-mail and calendaring functions. A non-exhaustive list of available EIM platforms includes those offered by Microsoft Corporation, Oracle Corporation, IBM Corporation, and other more industry-focused EIM platforms, such as are offered by Thomson Reuters Corporation and by Bloomberg L.P. to financial services companies.

Another conventional form of messaging services—short message services (“SMS”)—also sometimes referred to as mobile messaging, was developed under the Global System for Mobile Communications (GSM) standards. However, SMS is now available on other mobile technologies and networks, including 3G, satellite and landline networks. SMS use standard (stateless) communication protocols to allow users of SMS-enabled devices, such as smart phones and other fixed or portable devices, to create, send and receive short text messages (up to 160 characters). SMS message delivery employs known “store and forward” technology. The SMS standard does not guarantee message delivery and verification of delivery may not be available in some SMS implementations. Most SMS messages are sent from mobile phone to mobile phone(s), i.e., from person-to-person(s) (P2P). However, application-to-person (A2P) type SMS messaging—between an application and application subscriber(s)—is growing. For example, social network services (SNS) increasingly use A2P-type messaging to send SMS text messages from their social network systems to their SNS participants. Multimedia message services (“MMS”) extend SMS capabilities beyond text to include multimedia content. SMS and MMS are collectively referred to herein as “SMS/MMS.” The spread of smartphones has contributed to the ubiquity of IMS, EIM, SMS, and MMS messaging (collectively or individually referred to herein, as the context indicates, as a “message” or “messaging.”

A social network refers to any online social structure where the users are connected by a common feature. The common feature can include (without limitation) explicitly defined relationships/connections, e.g., friendship, family, work, interests, as well as relationships implied by connections with other social network users. By way of example only, a first social network can be focused on business networking, a second social network focused on academics, a third more directed to local businesses, a fourth social network focused on dating, while other social networks have other specific or more general focus. The relationships/connections of a social network can be represented by a social graph, which can be stored in and accessed from a (local or remote) data store. A non-exhaustive list of social network services includes those offered by Twitter, Inc., LinkedIn Corporation, YouTube, LLC and under the Facebook® brand.

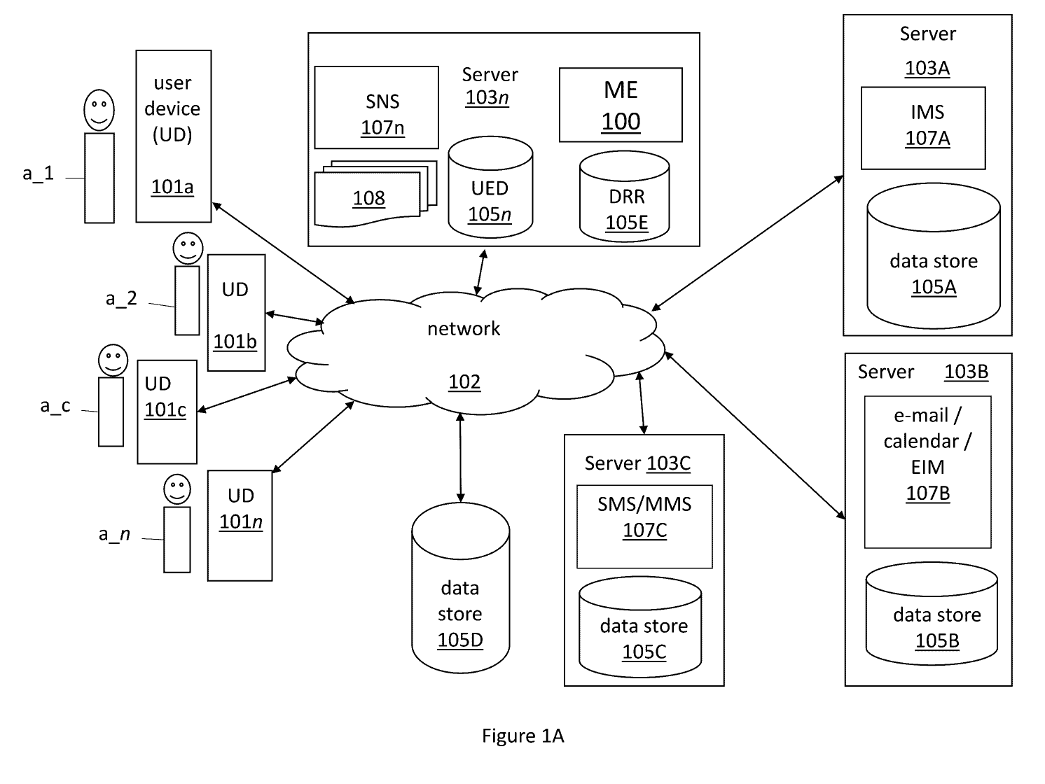

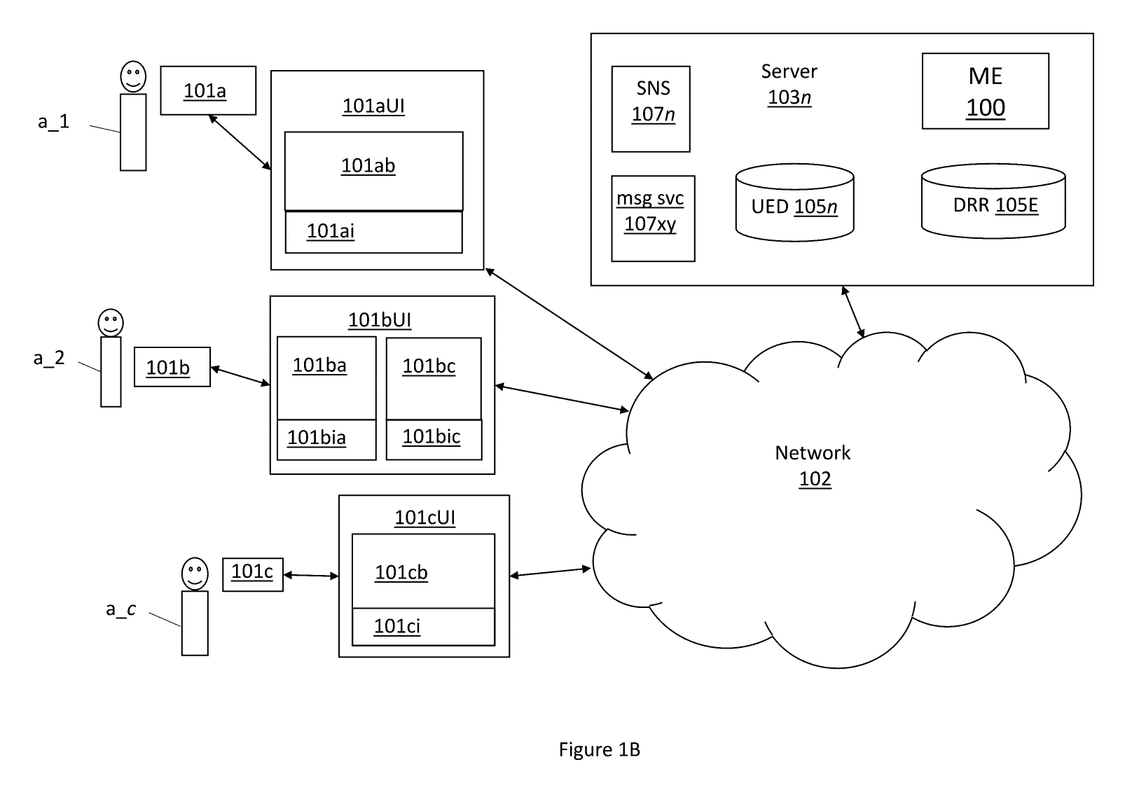

FIG. 1A depicts an embodiment of a system in accordance with the present invention for generating suggested personalized messages. A plurality of user devices (“UD”) 101a . . . 101n, servers 103A . . . 103n, services 107A . . . 107n and remote or local data stores/sources 105A . . . 105n, 108 are communicatively coupled to network 102 and each other. By way of example only, user devices 101a-101n can be personal computers, interactive televisions, mobile devices (such as smart phones and tablet computers), personal digital assistants (PDAs) camera phones, video recorders, audio/video players, radios, global positioning system (GPS) devices, or wearable devices (aka “wearable computers” or “wearables”) or any combination of the foregoing. A non-exhaustive list of wearables includes watches offered by Apple, Inc. and LG Electronics, Inc. and optical head-mounted displays offered by Google, Inc.

As is known, data/information may be stored on, or communicated via network 102 to one or more user devices 101a . . . 101n, servers 103A . . . 103n, services 107A . . . 107n, ME 100 and other data stores/sources 105A . . . 105n, 108. In some embodiments, ME 100 receives one or more messages from one or more user devices 101a . . . 101n associated with respective users a_1 . . . a_n over network 102. In some embodiments, part or all of the inventive message processing can be performed directly by and tightly coupled to ME 100, or indirectly performed by more loosely coupled processes or any suitable combination of the preceding.

In some embodiments, network 102 is the Internet, but other conventional (wired or wireless) network(s) (or combinations thereof) will suffice, such as one or more wide area networks (WAN), medium area networks (MAN), local area networks (LAN) and personal area networks (PAN). Also, as is known, one or more of devices 101a . . . 101n or servers 103A-103n may operate as a “server” or a “client” in a server-client network architecture, as a so-called “peer” device in a peer-to-peer environment, or as part of cluster or group—such as in a so-called server “farm” or “cloud.” In some embodiments, one or more devices 101a . . . 101n can perform the inventive messaging processing on a peer-to-peer basis. In some embodiments, the inventive messaging process is at least partially distributed across one or more devices, servers and other components of network 102.

As depicted in FIG. 1A, servers 103A . . . 103n host and execute services 107A-107n. As depicted, services 107A-107n include, by way of example and without limitation, one or more: conventional instant messaging services (IMS) 107A on server 103A; conventional integrated e-mail/calendaring/enterprise IM (EIM) services 107B, on server 103B; and SMS/MMS 107C, on server 103C. In some embodiments, Server 103n may include data/objects 108 associated with SNS 107n participants, such as a representation of such participants' social graph and or data associated with participants' user devices 101a . . . 101n.

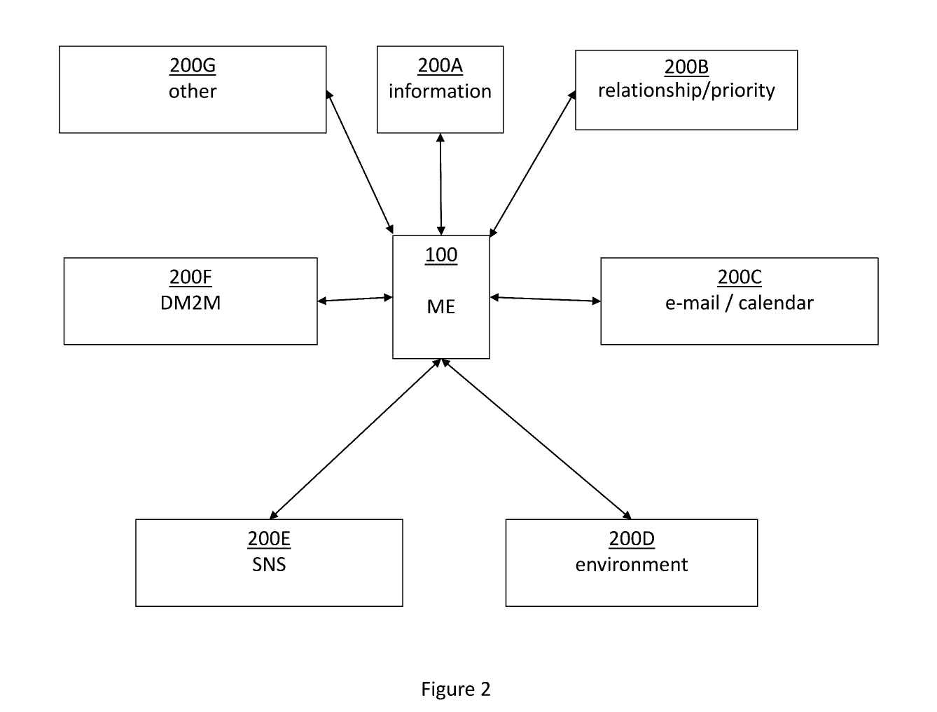

An embodiment of a message engine (“ME”) 100 in accordance with the present invention is hosted on server 103n. In some embodiments, ME 100 is embodied as software stored in computer memory and executing on processor components (not depicted) of server 103n. In some embodiments, ME 100 can be co-resident with one or more other services/applications, such as social network service/application (SNS) 107n on server 103n (as depicted). A non-exhaustive list of other servers/services and data sources (not depicted) that can provide input to ME 100 include: location/environment data such as are available from a conventional global positioning system (GPS) application, widely available on smart phones and automobile navigation systems; a micro-blogging server; a profile server, a web server, a search server and integrated search engine, such as is offered by Google, Inc., for retrieving results from the Internet that correspond to search terms input to the search engine; and other third party servers/services. A more detailed example of information sources and information processing will be described with reference to FIG. 2.

In some embodiments, devices 101a . . . 101n include conventional user interfaces (“UI”), which are adapted to interface with ME 100. An example (without limitation) of such UIs adapted in accordance with the present invention will be described with reference to FIG. 1B. As is known, UIs can facilitate the message recipient to view (on the applicable user device 101a . . . 101n) one or more of: a message; related information; and a suggested response to the message. In some embodiments, the UI is further conventionally adapted to enable dynamic interaction with the ME 100 message generation process. For example, the UI may include one or more action buttons (not depicted) to facilitate interaction with and the selection of a suggested message. By way of further example, the UI may be conventionally adapted to facilitate input/output, via touch screen and speech recognition and text-to-speech techniques. A non-exhaustive list of such interactions includes, but is not limited to, user input or modification of message context, as well as weightings and priorities applicable to message content, senders, other users or suggested messages

In some embodiments, ME 100 is conventionally adapted to interact with the UI to accept the input of and store/retrieve user provided profile or access information in user engagement data (UED) data store 105n or DRR 105E. By way of example only, such access information may include login information (such as user identification and password) and other information enabling access to information associated with services 107A . . . 107n, or data stores/sources 105A . . . 105D, 108.

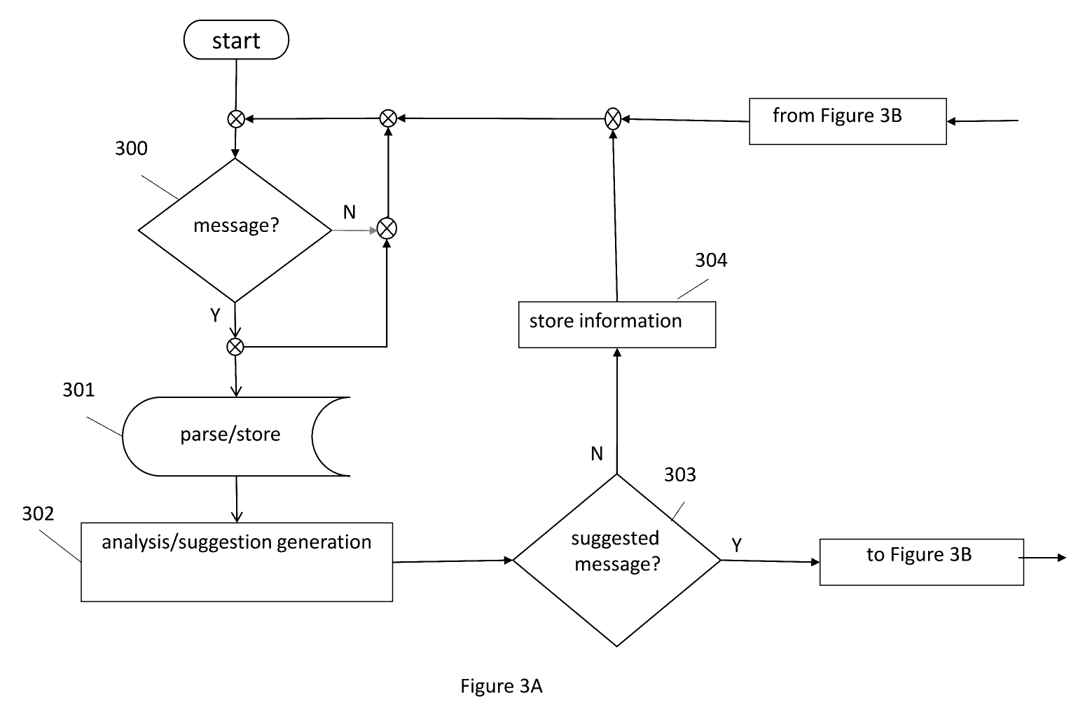

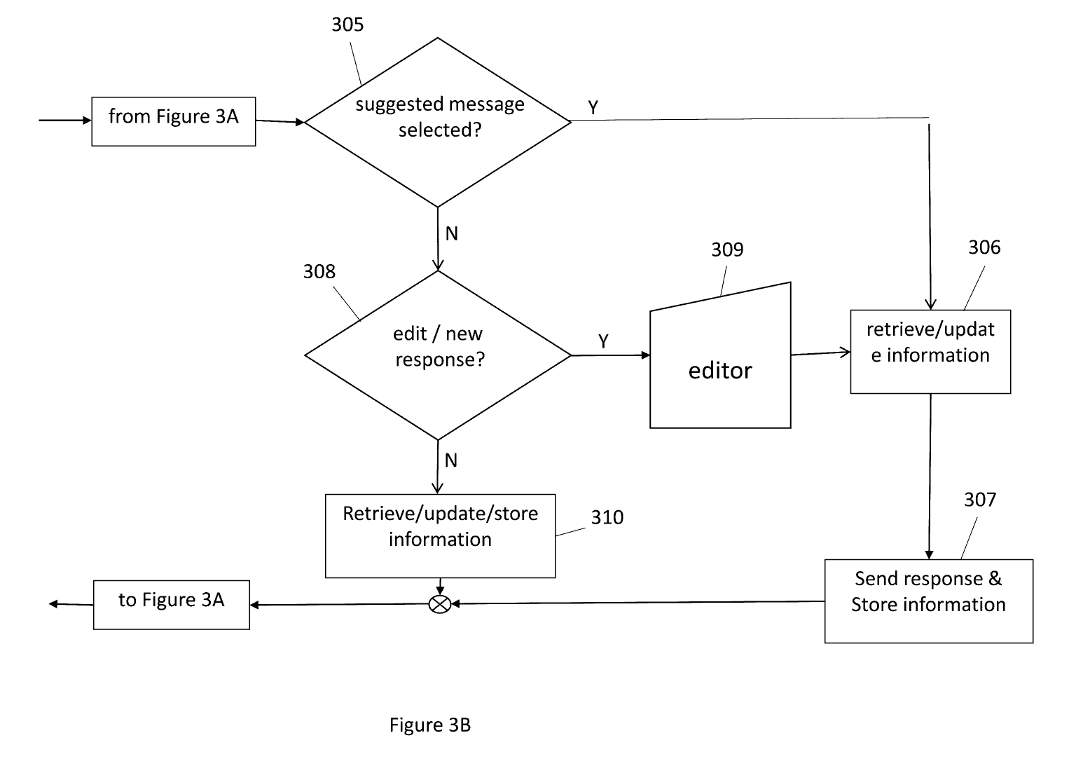

In some embodiments, conventional pre-or post-processing of information is performed. A few examples include (without limitation) one or more information: weightings, rankings, prioritizations, normalizations, comparisons, combinations, measurements, and modifications. In some embodiments, suggested messages are presented based on calculated relative probabilities. By way of further example, (without limitation) a message suggestion generation process may reflect access information or predefined relationship priority input by a user through a UI to user's device and stored in the device and/or another data store; derived from information retrieved from accessible service(s) or data store(s). An example (without limitation) of the processing of dynamic information as well as other information will be described in more detail with reference to FIG. 2. As is known, information can be tracked and stored in computer memory using conventional data structures. As will be described in more detail with reference FIGS. 3A-3B, dynamic information can be tracked and stored in computer memory using conventional data structures, by way of example only, a data table (also referred to as a dynamic information table).

FIG. 1B depicts a more detailed embodiment of certain aspects of FIG. 1A. In particular, user interfaces 101aUI . . . 101cUI of respective user devices 101a . . . 101c (depicted in FIG. 1B), will be described with reference to an embodiment of a computer-implemented process in accordance with the present invention. With reference now to FIG. 1B and for purposes of this example only, user devices 101a . . . 101c are smart phones. User a_c (Colleen) enters a message into input portion 101ci of the active message window 101ba of user interface 101cUI of device 101c “Hi Mary, I am at Java Joe's on J Street. How about meeting me for coffee?” and sends the message via conventional messaging service 107xy to business colleague Mary's device 101b. User a_2 (Mary) is driving home when the message is received on device 101b. Mary's device also includes messaging service 107xy functionality. An active message session window 101ba is opened on the user interface 101bUI of Mary's device and the message from Colleen is displayed therein. For purposes of this example and without limitation, device 101b is conventionally adapted to incorporate one or more features or functions, such as GPS, navigation, mapping, speech recognition, and text-to-speech. Mary's device 101b is also conventionally networked (“paired”) with her automobile (not depicted) systems. In this example, Mary's device 101b is adapted (through conventional techniques) to pre-process the message, e.g., parse it into its parts, extract excerpts of the message content, and retrieve other locally available information, such as GPS location, destination, navigation, and environment info. In some embodiments, relationship information and priority information associated with Colleen was previously specified by Mary and stored in local computer memory of device 101b and is retrieved along with access information for available network services such as social network service (SNS) 107n. Mary's device 101b is adapted to forward the pre-processed message, which may include other information, via network 102 to ME 100 for further processing.

ME 100 receives the forwarded, pre-processed message. ME 100 uses the message excerpts to query a data structure stored in a pre-defined computer memory space (not depicted) of server 103n to determine if there is a concurrently open message session involving user a_2 (Mary) and another user. In some embodiments, the data structure is a conventional table-like structure (also referred to herein as a dynamic information table), an example of which will be discussed with reference to FIGS. 3A-3B. One example (without limitation) of such pre-defined memory space can be implemented in computer hardware through conventional dynamic random-access memory (DRAM). In some embodiments, portions of the pre-processed message are tentatively stored in the dynamic information table and in one or more persistent data stores such as UED 105n and DRR 105E. If a concurrently open message session is identified, ME 100 is adapted to retrieve information (also referred to herein as dynamic information) associated with the identified concurrently open message session that may be useful for the message suggestion process for the presently active message session between user a_2 (Mary) and user a_c (Colleen). In this example, the results of a query by ME 100 does not identify any such concurrently open message session and thus no dynamic information. Portions of the presently active message excerpts are stored in the pre-defined memory space for potential future re-use (as dynamic information).

Retrieved access information is used to query corresponding services 107A . . . 107n and data stores of interest for information. Retrieved environmental information, such as GPS/navigation information and functionality is used to determine Mary's current location, calculate/input a route into Mary's automobile navigation system, which calculates an estimated travel time to Java Joe's of 15 minutes. The retrieved information 200A is correlated/processed, and one or more suggested messages are transmitted to device 101b. For purposes of this example (without limitation), a suggested message is “Sounds great Colleen. I am in my car and should arrive at Java Joe's shortly.” The suggested message is received by device 101b and is displayed on user interface 101bUI of device 101b, which is conventionally paired to (and displayed on the connected graphical display of) the automobile's systems. For purposes of this example (without limitation), the suggested message is also converted to speech by connected conventional text-to-speech message functionality and the resulting audio output through the audio system (not depicted) of Mary's automobile. For purposes of this example (without limitation), Mary selects a suggested message using conventional voice-command technology, and the selected message is sent to and received by Colleen's device 101c. The received message is displayed in the now active message window 101cb of user interface 101cUI of device 101c. In this example, confirmation of message delivery is available through and requested from messaging service 107xy. Delivery confirmation is received by device 101b and is forwarded to ME 100, and the pre-defined computer memory space is updated with particulars, e.g., time and location of the meeting.

Later, while the message session between user a_2 (Mary) and a_c (Colleen) is still open, another user a_1 (Donna) opens a message session window 101ab in user interface 101aUl of her smart phone 101a. User a_1 (Donna) enters a message into the input portion 101ai of message session window 101ab of user interface 101aUl and sends the following message to user a_2 (Mary, Donna's mother) “Hi mom, can you buy some milk on your way home?” The message is received by user a_2's (Mary's) device 101b and another message session window 101ba is opened/activated in user interface 101bUI of device 101b with the message from Donna displayed therein. As before, the message is pre-processed by device 101b and is forwarded to ME 100 for further processing. ME 100 receives the pre-processed message, and ME 100 identifies a concurrently open message session between user a_2 (Mary) and user a_c (Colleen). Dynamic information regarding the meeting (e.g., time and location of the meeting) between Mary and Colleen at Java Joe's is retrieved from computer memory, and the dynamic information is used by ME 100 in the message suggestion generation process. In some embodiments, the dynamic information is supplemented by other historical/available information, such as scheduling information and other electronic communications.

In some embodiments, ME 100 leverages awareness of the dynamic information and (by way of example only) suggests a combination of messages that reflect such dynamic information. By way of example (without limitation), a first suggested message to be sent to user a_1 (Donna) is “Driving home now, I'll pick up some milk” and a second message to be sent to user a_c (Colleen) is “Sorry, I need to cancel our meeting at Java Joe's because of a late-breaking conflict.” Another example of a suggested message combination generated by ME 100 is: a first suggested message to user a_1 (Donna) “I promised to meet Colleen (from work) for coffee. Is it OK if I pick up milk after that ends (at 7 p.m.)? Let me know;” and a second message to user a_c (Colleen) “Sorry, I may need to cancel our meeting at Java Joe's because of a late-breaking conflict. I will let you know ASAP.” For purposes of this example only, Mary selects the latter combination message suggestion via user interface 101bUI of device 101b. In response to the selection, the first message of the selected message combination is sent via message session 101ba of device 101b and is received by and displayed on user interface 101aUI of user a_1's (Donna's) device 101a. The second message of the selected message combination is sent via message session 101bc of device 101b and is received by and displayed on user interface 101cUI of user a_c's (Colleen's) device 101c. Delivery confirmation of each message is requested/received by device 101b and is forwarded to ME 100. ME 100 receives the forwarded delivery confirmations, and the pre-defined memory space is updated to reflect the updated (pending) nature of the entries.

User a_1 (Donna) receives Mary's message on the user interface 101aUI of device 101a and sends a reply to Mary “The milk can wait until after 7 pm. Love, Donna.” User a_c (Colleen) receives the message sent to her by Mary on UI 101cUI of device 101c and replies to Mary “OK. Hope to see you soon.” Donna's and Colleen's respective reply messages are received by Mary's device 101b and displayed in the respective message session windows 101ba and 101bc of device 101b and on the connected display of her automobile. As before, the reply messages are converted to speech by the connected text-to-speech functionality and the audio played through the automobile's audio system. As before, the messages are pre-processed by device 101b and forwarded to ME 100 for further processing. ME 100 retrieves dynamic information from memory and correlates each message as a confirmatory response to Mary's respective prior messages. The status of the corresponding dynamic information is tentatively updated as “confirmed” and metadata/excerpts of the message are tentatively updated for possible future reference. ME 100 correlates each message to its corresponding message thread and generates/sends two suggested messages to user a_2's (Mary's) device 101b. As before, the messages are received by Mary's device 101b and displayed in the respective message session windows 101ba and 101bc of device 101b. The messages are also displayed on her automobile's connected display and converted to speech, and each is read to Mary by connected text-to-speech functionality. The first message is a suggested confirmation to Donna “OK. Love Mom.” The second message is a suggested response to Colleen “We are all set. See you at Java Joe's in a few.” Mary accepts and sends the respective suggestions to Donna and Colleen. Confirmation of delivery transmission is received and forwarded to ME 100, which commits the aforementioned tentative updates to storage.

FIG. 2 depicts a more detailed embodiment of the accessing and processing of information by ME 100. As depicted, processes 200B . . . 200G can include: a relationship/priority identifier 200B; an e-mail/calendar/message 200C; an environment identifier 200D; a social network service (SNS) 200E; a dynamic message-to-message (DM2M) 200F; and “other” 200G. In some embodiments, ME 100 and processes 200B . . . 200G are implemented as computer software executing on processor(s) (not depicted) to perform the operations described.

In some embodiments ME 100 accesses and uses information 200A stored (with reference also now to FIG. 1A) in one or more of: servers 103A . . . 103n; user devices 101a . . . 101n; and data stores/sources 105A . . . 105n, 108 (individually or collectively referred to herein as “data store(s),” as the context indicates. As is known, ME 100 and processes 200B-200G can access and use information 200A stored locally via conventional internal buses (not depicted) or remotely via network 102. By way of example only, ME 100 can store login information (such as user identification (UID) and password information) in UED 105 and subsequently retrieve/use it to access applicable services 107A . . . 107n and data stores, subject to conventional access controls. With reference now to FIG. 2, such information 200A and processes 200B . . . 200G can be further understood as follows:

Information 200A comprises information, including but not limited to user information, user data, user messages, and related content and metadata. By way of example only, information 200A can be a message composed by user a_1 (FIG. 1A) on device 101a and sent to device 101b of user a_2. In some embodiments, user a_2's device 101b is conventionally adapted to forward the message to ME 100 for processing and generation of one or more suggested messages. In some embodiments, such processing includes access to information 200A retrieved by ME 100 (or one or more processes 200B . . . 200G) from an accessible data store(s).

Referring again to FIG. 2, a relationship/priority 200B process is depicted. Relationship/priority 200B process refers to the identification of relationship or priority information 200A associated with one or more users a_1 . . . a_n. In some embodiments, one or more user devices 101a . . . 101n are adapted through a conventional UI to assign pre-defined relationship(s) or priority level(s) to one or more of users a_1 . . . a_n and information 200A. The relationship and priority information can be conventionally stored in UED 105n and be made accessible to or modifiable by or through one or more of the UI, relationship/priority 200B process, ME 100, and other 200G process(es). For example (without limitation), relationship/priority 200B process may query UED 105n for information 200A identifying: a relationship between user a_1 and user a_2; or a pre-defined priority that the information receiver has assigned to the message sender. By way of example only, relationship/priority identifier 200B process can use available information from social networking service 107n to infer a connection between a message sender and receiver.

With reference again to FIG. 2, an e-mail/calendar 200C process (sometimes referred to herein as e-mail 200C process) is depicted. An e-mail 200C process refers to the processing of information 200A available through conventional e-mail and calendaring services. In some embodiments, e-mail 200C process is adapted to communicate via ME 100, network 102 (FIG. 1A) and server 103B with e-mail/calendaring/scheduling 107B service (sometimes referred to herein as e-mail 107B services). By way of example only, the e-mail 200C process can interact with server 103B to access information, such as e-mail messages that have been received/sent by a user, a status of message(s) (read, unread, messages forwarded, replied) and e-mail threads/messages. A non-exhaustive list of such e-mail and/or calendaring services include, without limitation, those offered by Yahoo! Inc., Google Inc., and Microsoft Corporation. For clarity, although a single e-mail 107B (FIG. 1) service is depicted, e-mail process 200C may connect to and collect information from multiple user e-mail services.

With reference again to FIG. 2, an environment 200D process is depicted. Environment 200D process refers to the gathering and processing of various available geographic or environmental information to assist in the generation of suggested messages. By way of example only, a message received on device 101b, such as a mobile computer or smart phone, may include or have access (via wired or wireless connection) to location information such as satellite-based information from the global positioning system (GPS), cellular-based information from cell-phone tower triangulation techniques, and other systems. As is known, additional mapping or navigation applications/functionality may provide richer location, origin, directional or destination information to the environment identifier 200D process. A non-exhaustive list of other environmental information sources includes a microphone for audio-based information and an accelerometer for motion information. In some embodiments, environment identifier 200D process may obtain and provide environmental information to ME 100 to assist in the generation of suggested messages. By way of example only, environmental information may be combined with information obtained through e-mail/calendar 200C process to determine that a user is traveling to a scheduled event, and a message suggested that the user will respond after the scheduled event.

With reference again FIG. 2, an example of an SNS 200E process is depicted. SNS 200E process refers to the access/use of social media information as part of the inventive message generation process. As is known, such social media information includes, but is not limited to: social connections/links/status between users, with inanimate objects (such as photos, events, and web pages) and social graph depictions thereof, online social interactions, messages sent/received, information posted/reviewed, and any other user activity associated with social media. In some embodiments, SNS 200E process functions similarly to the e-mail 200C process, except that SNS 200E process accesses/uses information from available social media sources—such as SNS 107n (FIG. 1A). In some embodiments, SNS 200E process (directly or through ME 100) stores collected information for subsequent re-use. In some embodiments, SNS 200E process uses a publicly available application interface (API) to SNS 107n to access and store information in DRR 105E or UED 105n for future use. In some embodiments, local access to data/objects 108 is facilitated by a closer coupling of one or more 200B . . . 200G processes with local data stores, such as UED 105n and DRR 105E, depicted with regard to server 103n (FIGS. 1A, 1B).

With reference again to FIG. 2, an example of a dynamic message-to-message (DM2M) 200F process for managing dynamic information is depicted. In this example, a dynamic message-to-message process refers to leveraging information 200A from message sessions that may not otherwise be reflected in a computer-implemented message suggestion process. By way of example only, a message suggestion process for an active message session that may be impacted by another message session. By way of further example only: depending on the implementation particulars of a messaging service (e.g., IMS/EIM/SMS/MMS), where the other message session is concurrently open with the active message session; or the other message session is a closed message session that contains relevant information no longer accessible e.g., not saved deleted, or otherwise not available from other information sources. In some embodiments, DM2M 200F process dynamically tracks and stores information exchanged during message sessions using conventional data structures so that dynamic information can be leveraged in the generation of suggested messages. As will be described in more detail with reference to FIGS. 3A-3B, dynamic information can be tracked and stored using a conventional data table structure. In some embodiments, dynamic information is supplemented with other information 200A obtained through one or more other processes 200B . . . 200E, 200G, services 107A . . . 107n and data stores. A non-exhaustive list of supplemental information includes, but is not limited to a detected location, a direction of travel, time of day, environment and calendar entries.

With reference again to FIG. 2, an example of an “other” 200G process is depicted. Other 200G process refers to the processing of other available information relevant to one or more users a_1 . . . a_n. In some embodiments, other 200G process collects information via network 102 that is contained in or derived from user interactions with other systems, services or sources. The collected information is processed and communicated to ME 100 for consideration in the generation of suggested messages. One example (without limitation) of such other information are micro-blog messages and associated user status information from micro-blogging and other sources. Another example (without limitation) of such other information is contextual, tone, feelings or emotion information communicated through the use of text characters, graphical icons or multimedia in or with messages. As is known, one or more ASCII punctuation characters can represent so-called emoticons (emotions+icons) and Unicode character set V 6.0 (published October 2010), and later versions include emoticons.

FIGS. 3A and 3B depict an embodiment of a computer-implemented method in accordance with the present invention. In some embodiments, one or more aspects of such computer-implemented method are implemented as computer readable program instructions (software). As is known, such computer-readable program instructions can be stored on computer program product (discussed in more detail below) and downloaded (via network 102) for execution on one or more of devices 101a . . . 101n and servers 103A . . . 103n.

By way of introduction to the example depicted in FIGS. 3A and 3B, with reference to FIG. 1A, user a_c (Colleen) accesses a message service that is available because of her participation in social networking service SNS 107n. SNS 107n is running on server 103n, which implements a conventional multitasking computer operating system and background process that “listens” for message input (sometimes referred to as a daemon). The daemon is communicatively coupled to ME 100. ME 100 has access to relationship and priority information previously specified by Wendy for Colleen, along with access and other information regarding service(s) 107A-107n used by Wendy and for other data store(s).

For purposes of this example, the message service offered by SNS 107n does not store the contents of a message session after the message session is closed. Colleen logs in to the SNS 107n application on her smart phone device 101c and sends a message to former business colleague and friend user a_2 (Wendy) “Hi Wendy, I am at Java Joe's on J Street. Can you join me for a quick catch up?” Wendy is also active in SNS 107n and uses its messaging service. Wendy is driving home when the Colleen's message is received on her smart phone device 101b. Wendy's device 101b is conventionally connected via the IEEE 802.15 standard (aka “Bluetooth”) to her automobile's audio, navigation and other systems (e.g., speech recognition and text-to-speech). Wendy's device 101b is conventionally adapted to forward Colleen's message to ME 100

With reference now to FIG. 3A, in step 300, the message forwarded from Wendy's device 101b to ME 100 is detected by the background process (daemon) on server 103n. As is known, the daemon process forks, with the inventive processing of the message proceeding to step 301, while the daemon returns to step 300, listening for message input.

In step 301, the message is, in some embodiments, conventionally parsed and excerpts of the message copied into a data store such as UED 105n or DRR 105E for possible re-use. By way of example only, such message excerpts can provide information about the message source/sender/recipient, message type, date, time, context and other information obtained by excerpting certain pre-defined keywords. The computer-implemented process then proceeds to step 302.

In step 302, ME 100 uses message excerpts identifying the message sender/receiver to retrieve relationship, priority and access information from storage, such as UED 105n or DRR 105E. The retrieved access information indicates that Wendy uses SNS 107n and e-mail/calendar service 107B and retrieved priority information indicates that Wendy has assigned Colleen to a mid-level (“friend”) priority. ME 100 also uses the message excerpts identifying the message receiver to query computer memory for associated dynamic information. As will be discussed in more detail below, such dynamic information can be stored in a table, but numerous other conventional data structures and techniques are equally viable. For purposes of this example, no dynamic information associated with Wendy (the message receiver) is currently found. In some embodiments, SNS 107n is queried to obtain, derive, supplement or confirm relationship or priority information. Retrieved access information can also be used to query corresponding services 107A . . . 107n and data stores of interest for information. In some embodiments, available environmental information, such as GPS/navigation information and functionality is used to determine Wendy's current location, calculate/input a route into Wendy's automobile navigation system and determine an estimated travel time to Java Joe's. In some embodiments, the excerpted message content is analyzed, such as through conventional natural language processing technology, and provides contextual hints and other information. By way of example only, such information can facilitate classification of the message type, e.g., in this case as a “meeting.” In some embodiments, excerpts of previous message exchanges between Wendy and Colleen (if any) are retrieved from storage and analyzed for possible re-use during the message suggestion process. The retrieved information 200A is correlated and processed, which may include intermediate weighting/ranking, and suggested messages can be generated. The computer-implemented process proceeds to step 303.

In step 303, generated suggested messages (if any) are presented to Wendy's device 101b, and in this example, through the networked systems of her automobile. If no messages are suggested, the computer implemented process proceeds to step 304 (see below). For purposes of this example only, suggested messages are generated and are presented to Wendy through the UI in a ranked (high to low) order based on suggested probabilities, one of which is “Sounds great Colleen. I am in my car and should arrive at Java Joe's in about 15 minutes” and the computer-implemented process proceeds to step 305 (FIG. 3B).

In step 305, if Wendy does not accept any suggested message, the computer-implemented process proceeds to step 308 (see below). For purposes of this example only, in step 305, Wendy selects/accepts the aforementioned suggested message, and the computer-implemented process proceeds to step 306.

In step 306, the dynamic information table (currently empty for purposes of this example only) is retrieved, and an information entry is tentatively created in the dynamic information table for subsequent storage (pending confirmation of message transmission) with message particulars, e.g., entry type, time, location, status and other message excerpts. In some embodiments, the UI is conventionally adapted to enable users to customize the layout of a dynamic information data structure. An example (without limitation) of a dynamic information table layout containing such tentative updates is illustrated below as Table 1:

TABLE 1

| entry #/ | name/ | start/ | | | |
|---|---|---|---|---|---|
| type | location | end time | status | source | other info |
| 1/ | Colleen/ | 06:05 p.m./ | confirmed | colleenC@ | |
| Meet | Java Joe's, | 07:05 p.m. | | sns7n.com | |
| | J Street | | | | |

In some embodiments, message content/context is excerpted and stored in DRR 105E or UED 105n for possible re-use. Those of ordinary skill in the art will appreciate that even if the message session information was separately transmitted to Wendy's e-mail/calendar service 107B, there would be (at best) some time lag before the information could be received by, reflected in and accessible through the e-mail/calendar service. The computer-implemented process proceeds to step 307.

In step 307, the accepted message is sent to Colleen, and Wendy closes the message session. Transmission of the message is confirmed, and the information updates and dynamic information table stored in one or more of computer memory, DRR 105E, and UED 105n. In some embodiments, excerpts of message content are also stored in one or more of DRR 105E and UED 105n. The computer-implemented process then returns to step 300 (FIG. 3A).

With reference now to step 308, if all suggested messages were rejected in step 305 (see above), the user is presented in step 308 with other options. By way of example only, such options can be presented through a conventional UI (not depicted) and include: selection and editing of a suggested message; creation of an entirely new message; selection from among one or more generic messages such as “Sorry, can't chat right now;” or some combination of the foregoing. If the user declines the other options presented, the computer-implemented process proceeds to step 310. If the user selects one of the presented options (such as an option to select and edit a suggested message), the computer-implemented process proceeds to step 309.

In step 309, the user may use conventional editing functionality to select/edit a suggested/generic message or create a new message. Upon completion of any edits, the computer-implemented process returns to steps 306, 307 (see above) and then to step 300 (FIG. 3A).

Continuing this example, shortly after that, while user a_2 (Wendy) is traveling to Java Joe's to meet user a_c (Colleen), another user a_1 (Ann—Wendy's daughter) sends a message from Ann's mobile device 101a to Wendy “Hi Mom, can you grab some milk on your way home?” As described above, the message is received by Wendy's cell phone 101b and is forwarded to ME 100.

In step 300, the message from Ann to Wendy (which has been forwarded to ME 100 on server 103n) is detected by the conventional background process (daemon) on server 103n. The process forks, with the forwarded message further processed in step 301, while the daemon exits and continues listening for message input in step 300.

In step 301, ME 100 (as described previously) parses the message, stores excerpts of the parsed message in computer memory and/or persistent data store(s) such as DRR 105E and the computer-implemented process proceeds to step 302.

In step 302, the message analysis and suggestion generation process begin. As described previously, ME 100 retrieves available dynamic information, (including any message excerpts stored in step 301), and other information not forwarded from user a_2's (Wendy's) device 101b, such as specified relationship and priority information for Ann, along with any access information regarding available services, information from specified data stores of interest (collectively information 200A (FIG. 2)). In this example, the dynamic information table is retrieved and the entry (see e.g., Table 1 above) with details of the meeting that user a_2 (Wendy) has just planned with Colleen is identified. ME 100 correlates the information 200A, including the dynamic information, as part of the message generation process. As described previously, ME 100 uses the information in the generation of suggested message(s) and the computer-implemented process proceeds to step 303.

In step 303, generated suggested message(s) (if any) are displayed on the UI 101bUI (FIG. 1B) of Wendy's device 101b and her automobile's connected systems. In this example, the suggested messages are presented in a ranked (high to low) order and include probability percentages (%). An example of such ordered suggested messages in response to Ann's message is illustrated in Table 2 below:

TABLE 2

| Select # | Suggested Message | % |
|---|---|---|
| 1 | “I can pick up milk after my meeting ends—at about | 60 |
| | 7 p.m. OK? Luv, Mom.” | |
| 2 | “I can either cancel a meeting planned | 40 |
| | for 6-7 p.m. and bring milk | |
| | home now—or I can do it after my 7 p.m. meeting. | |
| | Let me know either way. Luv, Mom.” | |

The computer-implemented process proceeds to step 305 (FIG. 3B).

Referring now to step 305, for purposes of this example only, assume that Wendy (via the UI) chooses selection #2 from Table 2 (above), and the computer-implemented process proceeds to step 306.

In step 306, the dynamic information table (see e.g. Table 1) is retrieved, a new entry created, with metadata and particulars of the selected message and other relevant entries updated. An example of a tentatively updated (pending confirmation of transmission) dynamic information table is illustrated below as Table 1a. With reference now to Table 1a, the entries reflect tentative updates (pending confirmation of transmission). In particular, as illustrated, the status column of entry #2 in Table 1a has been modified to a “pending” status and marked with an * to indicate (as illustrated by the other info column) its linkage (in this example) to entry #1. The status column of entry #1 has also been modified from the previous “sent” status to “waiting for response” and likewise marked with an * to indicate its linkage to entry #2. In this example, DRR 105E is also tentatively updated (pending confirmation of transmission) with applicable metadata and excerpts of the latest message exchange, for possible future reference.

TABLE 1a

| entry #/ | name/ | start/ | | | |
|---|---|---|---|---|---|
| type | location | end time | status | source | other info |
| 1/ | Ann | 05:45 p.m./ | Sent | 9141234567 | “I can either |
| Message | | 05:47 p.m. | waiting | | cancel |
| | | | for a | | a meeting |
| | | | response* | | planned |
| | | | | | for 6-7 p.m. |
| | | | | | and bring |
| | | | | | milk home |
| | | | | | now—or |
| | | | | | I can do it |
| | | | | | after my 7 |
| | | | | | p.m. meeting. |
| | | | | | Let me |
| | | | | | know either |
| | | | | | way. |
| | | | | | Luv, Mom.” |
| 2/ | Colleen/ | 06:05 p.m./ | pending* | colleenC@ | * linked |
| Meet | Java Joe's, | 07:05 p.m. | | sns7n.com | entries |
| | J Street | | | | |

The computer-implemented process proceeds to step 307.

In step 307, the selected message (ref. step 305, select #2 in Table 2) is sent to Ann. In this example, the tentative information updates (in step 306) to the dynamic information table (Table 1a) are confirmed/stored in UED 105n, and any tentative information updates to metadata and excerpts of the conversation are stored in one or more of DRR 105E and UED 105n for possible future reference and re-use. The computer-implemented process returns to step 300 (FIG. 3A).

In this example, Ann receives the message from Wendy and Ann replies, “It can wait Mom. See you after 7 pm. Love, Ann.” The message is sent to Wendy, forwarded and detected as described above in step 300, and the computer-implemented process again proceeds to step 301.

In step 301, ME 100 parses the message, stores excerpts of the parsed message in a data store such as DRR 105E and the computer-implemented process proceeds to step 302.

In step 302, the analysis/generation process commences (as described previously). In this example, ME 100 retrieves the dynamic information table (see Table 1a). Based on the (parsed) message contents, information from the dynamic information table, ME 100 identifies the latest message (from Ann) as a confirmatory response to entry #1 in Table 1a above. As before, the dynamic information table is tentatively (pending confirmation of transmission) updated. An example of such a tentatively updated table is illustrated below as Table 1b. With reference now to Table 1b, the table entries reflect several tentative updates as compared to Table 1a (above). For example, the “status” column of Entry #3 in Table 1b is updated to “Confirmed” from its previous “pending” status (ref. Entry #2, Table 1a). The status column for Entry #2 in Table 1b is updated to “Confirmed” from its previous “waiting for response” status (ref. Entry #1, Table 1a). The “entry #/type” column for message-type entries #1 and #2 in Table 1b are updated with an * to indicate their linkage/relatedness (ref. “other info” column of Entry #2 in Table 1a). In this example, a reminder-type alarm has also been set to remind Wendy (at 7 p.m.) to buy milk on her drive home, as indicated by the + symbol and informational note in the other info column for entry #2 in Table 1b. As before, DRR 105E and UED 105n are tentatively updated (pending confirmation of transmission) with metadata and excerpts of the conversation, for possible future reference.

TABLE 1b

| entry #/ | name/ | start/ | | | |
|---|---|---|---|---|---|
| type | location | end time | status | source | other info |
| 1/ | Ann/ | 05:48 p.m./ | Com- | | “OK Mom. |
| Message* | | 05:48 p.m. | plete | | Love, Ann” |
| 2/ | Ann/ | 05:45 p.m./ | Con- | 9141234567 | “I can pick |
| Message* | | 05:47 p.m. | firmed | | up some |
| | | | | | milk after my |
| | | | | | meeting |
| | | | | | ends—at |
| | | | | | about 7 |
| | | | | | p.m. OK?” |
| | | | | | * linked |
| | | | | | entries + |
| | | | | | reminder |
| | | | | | set for |
| | | | | | 7 p.m. |
| 3/ | Colleen @ | 06:05 p.m./ | Con- | colleenC@ | |
| Meet | Java Joe's, | 07:05 p.m. | firmed | sns7n.com | |
| | J Street | | | | |

The computer-implemented process proceeds to step 303.

In step 303, as described above, ME 100 generates and displays a message on the UI of Wendy's device 101b and the automobile's connected systems. In this example, the message displayed indicates the confirmatory nature of Ann's message and that no response is required. The computer-implemented process proceeds to step 304.

In step 304, tentative updates (if any, such as to Table 1b (step 303) are confirmed, and the updated information and dynamic information table are stored in one or more of server 103n computer memory, UED 105n and DRR 105E. In some embodiments, tentative updates to metadata and excerpts of the message are stored in one or more of UED 105n and DRR 105E data stores, for possible future reference and re-use. The computer-implemented process proceeds to step 300.

The present invention may be a system, a method, or a computer program product. The computer program product may include a computer-readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have illustrated examples of architecture, functionality, and the operation of various embodiments of devices, methods, and computer program products in accordance with of the present invention. In this regard, each block in the flowchart or block diagrams may represent a module, segment, or portion of computer executable instructions for implementing the corresponding logical function(s). It is understood that the functions noted in a given block (or step) may occur in a different order from the examples described in the Detailed Description and Drawings. For example, two blocks shown in succession may, in fact, be executed substantially concurrently (and vice versa), or the blocks may sometimes be executed in the reverse order, depending upon the functionality involved. It is also understood that a block (and/or combination of blocks) of the block diagrams and/or flowcharts can be implemented by special purpose hardware-based systems and/or combinations of such hardware with computer instructions that perform the specified functions or process steps.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving a first message, including first information associated with the first message, sent from a first sending device to a first receiving device under a first active message session;
processing and storing at least portions of the first information, in response to receipt of the first message;
receiving a second message, including second information associated with the second message, sent from a second sending device to the first receiving device under a second active message session;
retrieving at least portions of the first information;
processing and determining a correlation between the second information and the at least portions of the first information, in response to said retrieving at least portions of the first information; and
generating and communicating at least one suggested message to the first receiving device based on correlated information, in response to said processing and determining a correlation between the second information and the at least portions of the first information.

2. The computer-implemented method of claim 1, further comprising closing the first active message session, in response to said processing and storing at least portions of the first information.

3. The computer-implemented method of claim 1, wherein the first receiving device is a mobile device, the first message and the second message are received by the mobile device and wherein said processing, retrieving and generating are performed by the mobile device.

4. The computer-implemented method of claim 1, wherein at least one of the first message and the second message are communicated through a messaging service selected from a group consisting of SMS, MMS, IMS and EIM.

5. The computer-implemented method of claim 1, further comprising:
receiving and storing priority information associated with the first receiving device; and
retrieving the priority information, in response to said receiving a second message;
wherein said generating and communicating at least one suggested message to the first receiving device is in response to said retrieving the priority information.

6. The computer-implemented method of claim 1, wherein at least one of the first information and the second information, includes contextual information selected from a group consisting of location information, time of day information, motion information, and direction of travel information, in response to said receiving a second message;
wherein said generating and communicating at least one suggested message to the first receiving device based on correlated information, is based on the contextual information.

7. The computer-implemented method of claim 1, said processing and determining a correlation between the second information the at least portions of the first information, further comprising:
receiving and storing, access information for a social networking service associated with receiver of a message; and
retrieving the access information and accessing social networking information using the access information, in response to said receiving a second message;
wherein said generating and communicating at least one suggested message to the first receiving device based on correlated information, is based on the social networking information.

8. The computer-implemented method of claim 7, wherein the social networking service is selected from a group consisting of: a business-focused networking service, an academic-focused networking service, a blogging-focused networking service, and a dating-focused networking service.

9. A computer program product, comprising a computer-readable storage medium having program code embodied therein, the program code executable by at least one processor to cause the electronic device to perform a computer-implemented method comprising:
receiving a first message, including first information associated with the first message, sent from a first sending device to a first receiving device under a first active message session;
processing and storing at least portions of the first information, in response to receipt of the first message;
receiving a second message, including second information associated with the second message, sent from a second sending device to the first receiving device under a second active message session;
retrieving at least portions of the first information;
processing and determining a correlation between the second information and the at least portions of the first information, in response to said retrieving at least portions of the first information; and
generating and communicating at least one suggested message to the first receiving device based on correlated information, in response to said processing and determining a correlation between the second information and the at least portions of the first information.

10. The computer program product of claim 9, further comprising closing the first active message session, in response to said processing and storing at least portions of the first information.

11. The computer program product of claim 9, wherein the first receiving device is a mobile device, the first message and the second message are received by the mobile device, and wherein said processing, retrieving and generating are performed by the mobile device.

12. The computer program product of claim 9, wherein at least one of the first message and the second message are communicated through a messaging service selected from a group consisting of SMS, MMS, IMS and EIM.

13. The computer program product of claim 9, further comprising:
receiving and storing priority information associated with the first receiving device; and
retrieving the priority information, in response to said receiving a second message;
wherein said generating and communicating at least one suggested message to the first receiving device is in response to said retrieving the priority information.

14. The computer program product of claim 9, wherein at least one of the first information and the second information, includes contextual information selected from a group consisting of location information, time of day information, motion information, and direction of travel information, in response to said receiving a second message; and wherein said generating and communicating at least one suggested message to the first receiving device based on correlated information, is based on the contextual information.

15. The computer program product of claim 9, said processing and determining a correlation between the second information the at least portions of the first information, further comprising:
receiving and storing, access information for a social networking service associated with a message receiver; and
retrieving the access information and accessing social networking information using the access information, in response to said receiving a second message;
wherein said generating and communicating at least one suggested message to the first receiving device based on correlated information is based on the social networking information.

16. The computer program product of claim 9, wherein the social networking service is selected from a group consisting of: a business-focused networking service, an academic-focused networking service, a blogging-focused networking service, and a dating-focused networking service.

17. A computer system, comprising:
at least one processor;
a memory coupled to the processor, said memory storing message engine computer program code executable on the processor to cause the computer system to perform a computer-implemented method comprising:
receiving a first message, including first information associated with the first message, sent from a first sending device to a first receiving device under a first active message session;
processing and storing at least portions of the first information, in response to receipt of the first message;
receiving a second message, including second information associated with the second message, sent from a second sending device to the first receiving device under a second active message session;
retrieving at least portions of the first information;
processing and determining a correlation between the second information and the at least portions of the first information, in response to said retrieving at least portions of the first information; and
generating and communicating at least one suggested message to the first receiving device based on correlated information, in response to said processing and determining a correlation between the second information and the at least portions of the first information.

18. The computer system of claim 17, said memory storing message engine computer program code executable on the processor to cause the computer system to perform a computer-implemented method, further comprising:
receiving and storing priority information associated with the first receiving device; and
retrieving the priority information, in response to said receiving a second message;
wherein said generating and communicating at least one suggested message to the first receiving device is in response to said retrieving the priority information.

19. The computer system of claim 17, wherein said memory storing message engine computer program code executable on the processor to cause the computer system to perform said processing and determining a correlation between information associated with the second message and retrieved information associated with the first message, further comprises:
receiving and storing access information for a social networking service associated with receiver of a message; and
retrieving the access information and accessing social networking information using the access information, in response to said receiving a second message;
wherein said generating and communicating at least one suggested message to the first receiving device based on correlated information is based on the social networking information.

20. The computer system of claim 17, said memory storing message engine computer program code executable on the processor to cause the computer system to perform a computer-implemented method, further comprising closing the first active message session, in response to said processing and storing at least portions of the first information.
